(19) United States
(12) Patent Application Publication
(10) Pub. No.: US 2011/0213690 A1
(43) Pub. Date: Sep. 1, 2011

(54) CARBON FOOTPRINT DETERMINATIONS

(75) Inventors: Debashis Ghosh, Charlotte, NC (US); Sudeshna Banerjee, Waxhaw, NC (US); Mark V. Krein, Charlotte, NC (US); Sreedevi Gummuluri, Charlotte, NC (US); Thayer S. Allison, JR., Charlotte, NC (US); David Joa, Irvine, CA (US); Kurt D. Newman, Matthews, NC (US); Yanghong Shao, Charlotte, NC (US); Timothy Bendel, Charlotte, NC (US)

(73) Assignee: BANK OF AMERICA CORPORATION, Charlotte, NC (US)

(21) Appl. No.: 12/713,618

(22) Filed: Feb. 26, 2010

(51) Int. Cl. G06Q 99/00; G06Q 50/00; G06Q 40/00

(52) U.S. Cl. 705/37; 705/317

(57) ABSTRACT

Described herein are various apparatuses, methods, and computer program products for providing a carbon-footprint modeling environment that determines a consumer's carbon footprint based on the consumer's acquisition of goods and/or services, as indicated by the consumer's transaction data. For example, the carbon-footprint modeling environment collects the consumer's transaction data for a predefined period of time and identifies transaction data that indicates the consumer's acquisition of goods and/or services that, when produced and/or consumed, result in greenhouse gas emissions. According to some embodiments, the carbon-footprint modeling environment categorizes goods and/or services into, for example, the following categories: transportation, housing, food, waste, and miscellaneous. Based on information gleaned from the consumer's transaction data, the modeling environment may determine the quantities of goods and services the consumer consumed in each of the categories and then apply conversion ratios to convert the respective quantities of goods and/or services consumed into units of greenhouse gas emissions.

### FIELD

In general, embodiments of the present invention relate to apparatuses, methods, computer program products, and other tools for determining the carbon footprint of an individual or an organization.

### BACKGROUND

According to the United States Environmental Protection Agency (EPA), the term “global warming” refers to an average increase in the temperature of the atmosphere near the Earth's surface. More specifically, according to the EPA, global warming often refers to the warming of the Earth's surface that may be a result of increased emissions of greenhouse gases from human activities, such as burning fossil fuels. In an effort to reduce their contribution to global warming, many individuals and organizations are implementing strategies designed to reduce their “carbon footprint”, which is a term that refers to the amount of greenhouse gases that an individual or an organization emits. However, individuals and organizations may not have the tools necessary to accurately determine their carbon footprint.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In general, described herein are various apparatuses, methods, computer program products, and other tools for providing a carbon-footprint modeling environment that determines a consumer's carbon footprint based on the consumer's acquisition of goods and/or services, as indicated by the consumer's transaction data. For example, the carbon-footprint modeling environment collects the consumer's transaction data for a predefined period of time and identifies transaction data that indicates the consumer's acquisition of goods and/or services that, when produced and/or consumed, result in greenhouse gas emissions. According to some embodiments, the carbon-footprint modeling environment categorizes goods and services. For example, the carbon-footprint modeling environment may categorize goods and services into at least one the following categories: transportation, housing, food, waste, and miscellaneous. According to some embodiments, the carbon-footprint modeling environment, based on information gleaned from the consumer's transaction data, determines the quantities of the goods and services the consumer consumed in each of the categories and then applies conversion ratios to convert the respective quantities of goods and/or services consumed into units of greenhouse gas emissions.

For example, embodiments of the present invention provide an apparatus having a memory device operatively coupled to a processor. The memory device includes a plurality of transaction data for a consumer. The processor is configured to: (1) identify in the transaction data at least one transaction associated with emission of greenhouse gas; and (2) calculate a quantity of greenhouse gas emission associated with the at least one transaction.

In some embodiments of the apparatus, the at least one transaction is a plurality of transactions associated with emission of greenhouse gas. In some such embodiments, the processor is further configured to determine a carbon footprint for the consumer for a period of time by aggregating the quantity of greenhouse gas emissions associated with each of the plurality of transactions that occurred during the period of time.

In some embodiments of the apparatus, the processor is configured to identify the at least one transaction by being configured to identify in the transaction data the at least one transaction in which the consumer transacted with a business-merchant that is associated with goods or services that, when produced or consumed, result in the emission of greenhouse gas. In some embodiments of the apparatus, the processor is configured to identify the at least one transaction by being configured to identify in the transaction data the at least one transaction in which the consumer transacted with a business-merchant on a recurring basis and the business-merchant is associated with goods or services that, when produced or consumed, result in the emission of greenhouse gas. In some embodiments of the apparatus, the processor is configured to identify the at least one transaction by being configured to identify in the transaction data the at least one transaction in which the transaction involves at least a good or service that, when produced or consumed, results in the emission of greenhouse gas.

In some embodiments of the apparatus, the processor is configured to categorize the at least one transaction associated with emission of greenhouse gas. For example, the processor may be configured to categorize the at least one transaction into at least one of a transportation category and a housing category.

In some embodiments of the apparatus, the processor is configured to calculate the quantity of greenhouse gas emission associated with the at least one transaction by being configured to: (1) apply a conversion formula to convert a dollar-value associated with the transaction into a quantity of a good or service; and (2) apply a second conversion formula to convert the quantity of the good or service into a quantity of greenhouse gas emission that resulted from the production and/or consumption of the good or service.

Embodiments of the invention also provide a method, where the method involves: (1) collecting from a datastore a plurality of transaction data associated with a consumer; (2) identifying in the transaction data at least one transaction associated with emission of greenhouse gas; and (3) using a processor to calculate a quantity of greenhouse gas emission associated with the at least one transaction.

Embodiments of the invention also provide a computer program product for determining a carbon footprint of a consumer. The computer program product includes a non-transitory computer-readable medium having computer-executable program code stored therein. The computer-executable program code includes: (1) a first executable code portion configured to collect from a datastore a plurality of transaction data associated with a consumer; (2) a second executable code portion configured to identify in the transaction data at least one transaction associated with emission of a greenhouse gas; and (3) a third executable code portion configured to calculate a quantity of greenhouse gas emission associated with the at least one transaction.

Embodiments of the invention also provide an apparatus having a memory device with financial transaction data stored therein, where the financial transaction data includes information about a plurality of purchases made by a consumer. The apparatus also includes a processor operatively coupled to the memory device. The processor is configured to: (1) identify in the financial transaction data at least one purchase of a good or service the production or consumption of which results in a byproduct; and (2) calculate a quantity of the byproduct associated with the at least one purchase.

In some embodiments of the apparatus, the processor is further configured to: (1) identify in the financial transaction data a plurality of purchases made by the consumer during a period of time, wherein each of the plurality of purchases comprises a purchase of a good or service the production or consumption of which results in the byproduct; (2) calculate a quantity of the byproduct associated with each of the plurality of purchases; (3) aggregate the quantity of the byproduct associated with each of the plurality of purchases; and (4) determine a total quantity of the byproduct associated with the consumer for the period of time based at least partially on the aggregate of the quantity of the byproduct associated with the plurality of purchases.

In some embodiments of the apparatus, the financial transaction data includes information about purchases made using a financial account, such as information about electronic payments made using a bank account. In some embodiments of the apparatus, the byproduct includes one or more greenhouse gases, such as, but not limited to, carbon dioxide, methane, nitrous oxide, or chlorofluorocarbons.

In some embodiments of the apparatus, the processor is further configured to determine a byproduct footprint for a consumer based at least partially on the quantity of the byproduct associated with the at least one purchase. In some such embodiments, the processor is further configured to: (1) identify in the financial transaction data at least one byproduct-offsetting transaction for the consumer where the transaction is associated with a reduction of the byproduct; and (2) revise the byproduct footprint based at least partially on the at least one byproduct-offsetting transaction. In some embodiments, the byproduct-reducing transaction includes a purchase of a share of a byproduct offset fund, the byproduct offset fund comprising an investment in byproduct offsetting projects or organizations.

In some embodiments of the apparatus, the processor is further configured to display information about the consumer's byproduct footprint in the consumer's online banking environment. In some embodiments, the processor is further configured to display information about the consumer's byproduct footprint in relation to a byproduct footprint of an average or peer consumer.

Embodiments of the invention also provide a method involving: (1) accessing financial transaction data, wherein the financial transaction data comprises information about a plurality of purchases made by a consumer; (2) identifying in the financial transaction data at least one purchase of a good or service the production or consumption of which results in a byproduct; and (3) using a processor to calculate a quantity of the byproduct associated with the at least one purchase.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Reference will now be made to the accompanying drawings to describe some embodiments of the invention, wherein:

FIG. 1 provides a block diagram of a carbon-footprint modeling environment in which carbon-footprint modeling processes of the present invention are carried out, in accordance with one embodiment of the present invention;

FIG. 2 provides a flow diagram illustrating a process whereby the carbon-footprint modeling environment of FIG. 1 is utilized to calculate an individual consumer's carbon footprint for a period of time, in accordance with an embodiment of the present invention; and

FIG. 3 provides a flow diagram illustrating a process whereby the carbon-footprint modeling environment of FIG. 1 is utilized to identify transactions from among a consumer's transaction data that likely resulted in greenhouse gas emissions.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of apparatuses, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, credit card companies, payment network companies (e.g., Visa®, MasterCard®, American Express®, etc.), and/or the like. Additionally, disclosed embodiments may suggest or illustrate the use of agencies or contractors external to the financial institution to perform some of the calculations, data delivery services, and/or authentication services described herein. Furthermore, the illustrations provided herein are examples only, and an institution or business may implement the entire invention on their own computer systems or even a single work station if appropriate databases are present and can be accessed.

The term “consumer” as used herein refers to any individual or any business or non-business entity that buys or otherwise acquires goods and/or services. For example, in some instances, a consumer is an individual customer of a financial institution that uses the financial institution to complete financial transactions that include the purchase of goods and/or services. In some instances, a consumer is a business customer of a financial institution that uses the financial institution to complete financial transactions for a business, including the purchase of goods and/or services for the business.

The term “business-merchant” as used herein refers to any individual or any business or non-business entity that sells, distributes, trades or otherwise deals, either as a retailer or wholesaler, in goods and/or services. It should be appreciated that the term business-merchant as used herein includes individuals or business or non-business entities that actually produce/provide the goods and/or services being sold. It should also be appreciated that the term business-merchant as used herein includes individuals or business or non-business entities that distribute the goods and/or services but do not produce/provide the goods and/or services.

The term “transaction data” as used herein refers to any information relating to a consumer's acquisition of a good and/or service. Exemplary transaction data includes information about the good(s) and/or service(s) acquired as well as information about the consumer, the business-merchant from whom the consumer acquired the good(s) and/or service(s), and the transaction itself. For example, transaction data may include a description of the goods(s) and/or service(s), the quantity of goods(s) and/or service(s), and the price of the good(s) and/or service(s). Also, for example, transaction data may include the consumer's name and address, bank account number, and credit- or debit-card number and the name of the card-issuing bank. Transaction data also may include, for example, information about the business-merchant, such as the business name and location, the location where the exchange occurred, the name and routing number of the business-merchant's acquiring bank, and the account number of the business-merchant's account, which is held at the acquiring bank.

The term “carbon footprint” as used herein refers to at least an estimate of the total amount of certain greenhouse gas emissions that result from a consumer's consumption of good(s) and/or service(s) within a given period of time, as indicated by the consumer's transaction data. Although the term “carbon footprint” is used herein, the greenhouses gasses measured thereby are not necessarily limited to gasses including carbon, nor do they necessarily include all types of carbon gass. In this regard, in one embodiment, “greenhouse gases” include those gases in an atmosphere that absorb and emit radiation in the thermal infrared range or any gas that may contribute to a greenhouse effect. For example, some examples of greenhouse gases include, but are not limited to, carbon dioxide, methane, nitrous oxide, ozone, haloalkanes such as chlorofluorocarbons (CFCs), sulfur hexafluoride, hydrofluorocarbons, nitrogen trifluoride, perfluorocarbons, and the like.

In general terms, described herein are various apparatuses, methods, and computer program products for providing a carbon-footprint modeling environment that determines a consumer's carbon footprint based on the consumer's acquisition of goods and/or services, as indicated by the consumer's transaction data. For example, the carbon-footprint modeling environment collects the consumer's transaction data for a predefined period of time and identifies transaction data that indicates the consumer's acquisition of goods and/or services that, when produced and/or consumed, result in (i.e., already resulted in or will result in) greenhouse gas emissions. According to some embodiments, the carbon-footprint modeling environment categorizes goods and services. For example, the carbon-footprint modeling environment may categorize goods and services into at least one the following categories: transportation, housing, food, waste, and miscellaneous. According to some embodiments, the carbon-footprint modeling environment, based on information gleaned from the consumer's transaction data, determines the quantities of the goods and services the consumer consumed in each of the categories and then applies conversion ratios to convert the respective quantities of goods and/or services consumed into units of greenhouse gas emissions.

It will be appreciated that some embodiments of the invention are only configured to try to estimate a consumer's carbon footprint by estimating only some (i.e., one or more) types of greenhouse gasses associated with the consumer's transactions. Furthermore, although embodiments of the invention are generally described herein as being configured to use a person's transaction data to estimate a consumer's carbon footprint based on an estimate of one or more greenhouse gasses resulting from goods and/or services purchased by the consumer, it will be appreciated that other embodiments of the invention can involve using similar apparatuses and methods to use a consumer's transaction data to estimate other environmental impacts of a consumer. For example, embodiments of the invention could estimate other environmental impacts of a consumer based on an estimate of one or more other byproducts resulting from goods and/or services purchased by the consumer. For example, other byproducts may include biodegradable waste, non-biodegradable waste, plastic waste, paper waste, metal waste, chemical waste, hazardous waste, other types of waste, other chemicals, other elements, other possible pollutants, and/or any other byproduct of the production or consumption of a good or service.

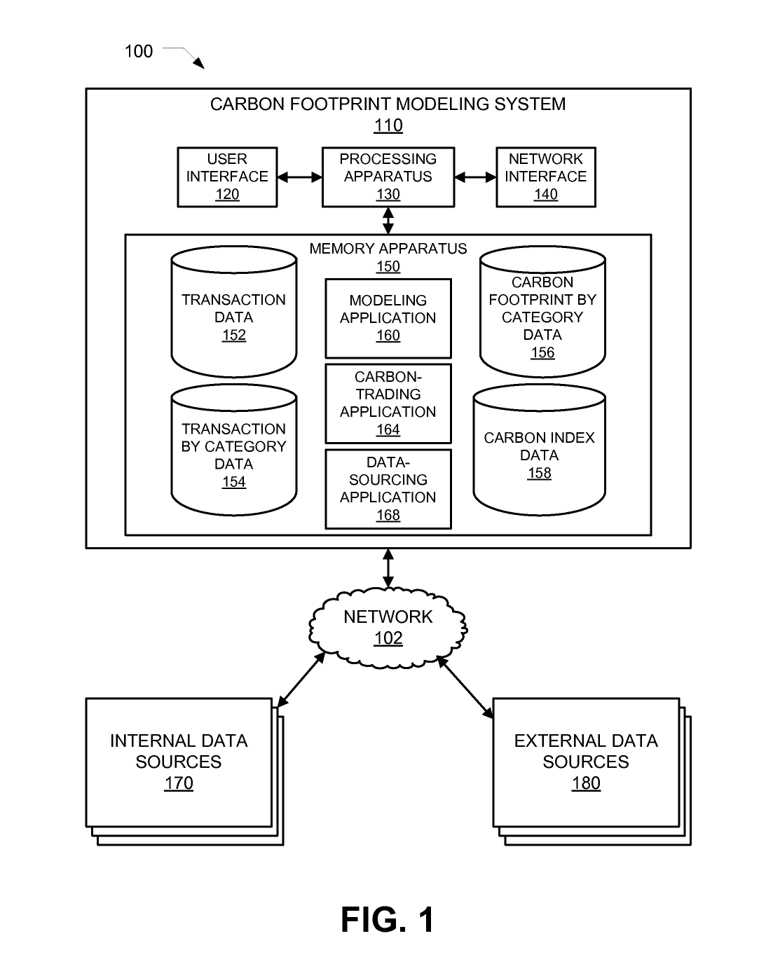

FIG. 1 provides a block diagram of a carbon-footprint modeling environment 100, in accordance with one embodiment of the present invention. The carbon-footprint modeling environment 100 generally includes a carbon-footprint modeling system 110 in communication with one or more internal data sources 170 and one or more external data sources 180 via a network 102. The carbon-footprint modeling system 110 comprises a user-interface apparatus 120, a network-interface apparatus 140, and a memory apparatus 150 operatively coupled to a processing apparatus 130.

As described in greater detail below, embodiments of the carbon-footprint modeling system 110 are generally configured to review a consumer's financial-transaction data taken across a predefined period of time and determine the consumer's carbon footprint for the period of time. Further, as described in greater detail below, some embodiments of the carbon-footprint modeling system 110 are configured to create a carbon-offset fund. According to an embodiment, the carbon-offset fund includes the consumers for whom a financial institution has transaction data (e.g., consumers having credit or demand deposit accounts with the financial institution). In this regard, according to some embodiments of the invention, the carbon-footprint modeling system 110 is owned, maintained, operated by, or operated on behalf of one or more financial institutions that have access to the transaction data of a large number of consumers. The carbon-footprint modeling system 110 may, in some embodiments, be integrated with other systems of such one or more financial institutions and may share at least some hardware, software, and/or other resources with such other systems. According to other embodiments of the invention, the carbon-footprint modeling system 110 is owned, maintained, operated by, or operated on behalf of one or more business-merchants or organizations of business-merchants that have access to consumer transaction data.

It should be appreciated that the carbon-footprint modeling system 110 may be owned, maintained, or operated by a third party that provides carbon-footprint information about consumers to subscribers. For example, subscribers may submit identifying information about an individual consumer that has consented to its information being made shared or made public, and the third party, using the carbon-footprint modeling system 110, provides the subscriber with carbon-footprint information about the individual consumer.

As used herein, the term “apparatus” refers to a device or a combination of devices having the hardware and/or software configured to perform one or more specified functions. Therefore, an apparatus is not necessarily a single device and may, instead, include a plurality of devices that make up the apparatus. The plurality of devices may be directly coupled to one another or may be remote from one another, such as distributed over a network.

It will be understood by one of ordinary skill in the art that, although FIG. 1 illustrates the user interface 120, network interface 140, memory apparatus 150, and processing apparatus 130 as separate blocks in the block diagram, these separations may be merely conceptual. In other words, in some instances, the user interface 120, for example, is a separate and distinct device from the processing apparatus 130 and the memory apparatus 150 and therefore may have its own processor, memory, and software. In other instances, however, the user interface 120 is directly coupled to or integral with at least one part of the processing apparatus 130 and at least one part of the memory apparatus 150 and includes the user interface input and output hardware used by the processing apparatus 130 when the processing apparatus 130 executes user input and output software stored in the memory apparatus 150.

As will be described in greater detail below, in one embodiment, the carbon-footprint modeling system 110 is entirely contained within a user terminal, such as a personal computer or mobile terminal, while, in other embodiments, the carbon-footprint modeling system 110 includes a central computing system, one or more network servers, and one or more user terminals in communication with the central computing system via a network and the one or more network servers. FIG. 1 is intended to cover both types of configurations as well as other configurations that will be apparent to one of ordinary skill in the art in view of this disclosure.

The user interface 120 includes hardware and/or software for receiving input into the carbon-footprint modeling system 110 from a user and hardware and/or software for communicating output from the carbon-footprint modeling system 110 to a user. In some embodiments, the user interface 120 includes one or more user input devices, such as a keyboard, keypad, mouse, microphone, touch screen, touch pad, controller, and/or the like. In some embodiments, the user interface 120 includes one or more user output devices, such as a display (e.g., a monitor, liquid crystal display, one or more light emitting diodes, etc.), a speaker, a tactile output device, a printer, and/or other sensory devices that can be used to communicate information to a person.

In some embodiments, the network interface 140 is configured to receive electronic input from other devices in the network 102, including the internal data sources 170 and the external data sources 180. In some embodiments, the network interface 140 is further configured to send electronic output to other devices in a network. The network 102 may include a direct connection between a plurality of devices, a global area network such as the Internet, a wide area network such as an intranet, a local area network, a wireline network, a wireless network, a virtual private network, other types of networks, and/or a combination of the foregoing.

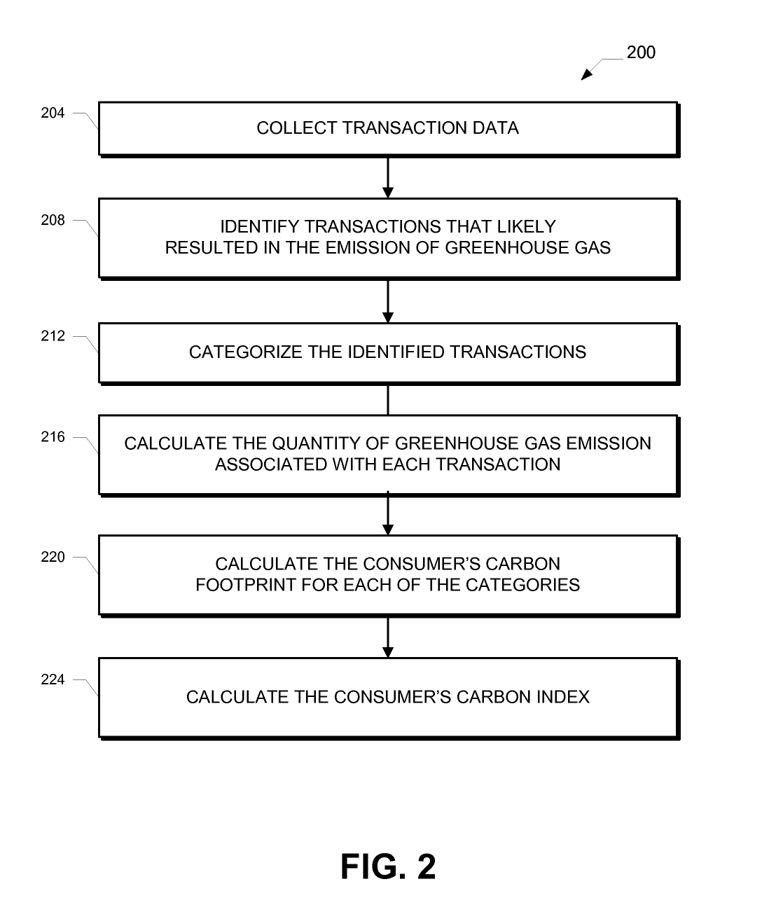

The processing apparatus 130 includes circuitry used for implementing communication and logic functions of the carbon-footprint modeling system 110. For example, the processing apparatus 130 may include a digital signal processor device, a microprocessor device, and various analog-to-digital converters, digital-to-analog converters, and other support circuits. Control and signal processing functions of the carbon-footprint modeling system 110 are allocated between these devices according to their respective capabilities. The processing apparatus 130 may include functionality to operate one or more software programs based on computer-readable instructions thereof, which may be stored in the memory apparatus 150. As described in greater detail below, in one embodiment of the invention, the memory apparatus 150 includes a modeling application 160, a carbon-trading platform application 164, and a data-sourcing application 168 stored therein for instructing the processing apparatus 140 to perform one or more operations of the procedures described herein and in reference to FIG. 2. Some embodiments of the invention may include other computer programs stored in the memory apparatus 150.

In general, the memory apparatus 150 is communicatively coupled to the processing apparatus 130 and includes computer-readable medium for storing computer-readable program code and instructions, as well as datastores containing data and/or databases. More particularly, the memory apparatus 150 may include volatile memory, such as volatile Random Access Memory (RAM) including a cache area for the temporary storage of data. The memory apparatus 150 may also include non-volatile memory that can be embedded and/or may be removable. The non-volatile memory can, for example, comprise an EEPROM, flash memory, or the like. The memory apparatus 150 can store any of a number of pieces of information and data used by the carbon-footprint modeling system 110 to implement the functions of the carbon-footprint modeling system 110 described herein.

In the illustrated embodiment, the memory apparatus 150 includes datastores containing transaction data 152, transaction-data-by-category data 154, carbon-footprint-by-category data 156, and carbon index data 158. According to some embodiments, for each individual consumer, the transaction data 152 includes, for example, financial transactions such as credit- and debit-card transactions, checking account transactions, electronic bill payment transactions, credit account transactions, loan transactions, and/or demand-deposit (DD) account transactions. These transactions can include purchases of, returns of, and/or payment for goods and/or services. In some embodiments, the transaction data 152 may be received from a user via the user interface 120, or may be obtained through electronic communication with another device, such as the internal data sources 170 or the external data sources 180, via the network 102 and utilizing the network interface 140, and then stored in the memory apparatus 150.

For example, in one embodiment, the transaction data 152 is data that a particular bank has accumulated about consumer transactions through its involvement in the transactions. For example, in some instances, the bank is the issuer of the consumer's credit card, debit card, or other payment device. When the consumer makes a purchase or other transaction using the bank-issued payment device, the bank receives an authorization request from a point-of-sale computer system. The authorization request generally includes transaction data about the purchase, such as a unique consumer identifier, a purchase amount, a date and time, and a merchant code. The bank may then be able to determine the consumer from the consumer identifier and determine the merchant's name, business, location, and/or other information about the merchant from the merchant code. In some embodiments, other transaction data is obtained from the point-of-sale computer system such as item-level information about the goods or services purchased including, for example, UPC (Universal Product Code) or SKU (Stock-Keeping Unit) codes for the goods purchased. In some embodiments, the consumer provides further information about one or more of the transactions. For example, the consumer may provide annotations about the transaction, using for example, the consumer's smart-phone at the point of sale. These annotations may be created by the consumer to help the consumer identify what the transaction was for when the consumer views his or her online banking statement, but may also be used by the carbon-footprint modeling system 110 to identify the goods and/or services involved in the transaction and/or the category of the transaction. In some embodiments, the consumer can categorize the consumer's transaction data manually by logging into an online banking system and assigning categories to each transaction identified therein.

According to some embodiments, the transaction-data-by-category data 154 includes a categorized summary of the transaction data that likely stems from a transaction that resulted in emission of greenhouse gases. For example, the categories of greenhouse gas emission may include transportation, housing, food, waste, and miscellaneous. For each category, the transaction-data-by-category data 154 includes a list of transactions in which the consumer acquired goods and/or services in that category.

It should be appreciated that, in addition to those transactions where the consumer acquired goods and/or services, in some embodiments of the invention, the transaction-data-by-category data 154 includes transactions where the consumer received payment for recycling goods and/or services in that category. For example, in the category of waste, a consumer's transaction-data-by-category data 154 may include consumer transactions where the consumer paid out fifty dollars for waste management services as well as transactions where the consumer received a payment of ten dollars from a recycling center for recycling paper, glass, plastic, aluminum, etc. Transactions such as these can indicate actions by the consumer to reduce the consumer's carbon footprint by, for example, reducing greenhouse gas emissions in the production of future goods or surfaces. In some embodiments, these types of transactions are used to reduce the consumer's carbon footprint or carbon index.

In some embodiments, the transaction-data-by-category data 154 may be received from a user via the user interface 120, or may be obtained through electronic communication with another device, such as the modeling application 160, which may obtain the data from the internal data sources 170 or the external data sources 180 via the network 102 using the network interface 140 and then stored in the memory apparatus 150.

According to some embodiments, the carbon-footprint-by-category data 156 includes carbon footprint statements for individual consumers, where a carbon-footprint statement summarizes the amount of greenhouse gases a customer was responsible for emitting in each category over a given period of time. For example, as mentioned above, the categories of greenhouse gas emission may include transportation, housing, food, waste, and miscellaneous. For each category, the carbon-footprint-by-category data 156 includes the amount of greenhouses gases that were emitted as a result of the consumer acquiring goods and/or services in that category. For example, in the category of transportation, a consumer's carbon-footprint-by-category data 156 indicates the amount of greenhouse gases that were emitted as a result of the consumer's acquisition of goods, e.g., automobile fuel, and/or services, e.g., airplane travel, related to transportation for a period of time. For example, for each consumer, the carbon-footprint-by-category data 156 indicates the number of units, e.g., tons, pounds, kilograms, etc, of greenhouse gas emissions, e.g., carbon, carbon dioxide, methane, etc., that the consumer is responsible for emitting in each category for a preselected period of time.

The carbon-footprint-by-category data 156 may be received from a user via the user interface 120, or may be obtained through electronic communication with another device, such as the modeling application 160, which may obtain the data from the internal data sources 170 or the external data sources 180 via the network 102 using the network interface 140 and then stored in the memory apparatus 150.

According to some embodiments, the carbon index data 158, for each consumer, indicates the total amount of greenhouse gases that were emitted as a result of the consumer's acquisition of goods and/or services across all categories. For example, for each consumer, the carbon index data 158 indicates the total number of units, e.g., tons, pounds, kilograms, etc, of greenhouse gas emissions, e.g., carbon, carbon dioxide, methane, etc., that the consumer was responsible for emitting across all categories for a preselected period of time. The carbon index data 158 may be received from a user via the user interface 120, or may be obtained through electronic communication with another device, such as the modeling application 160, which may obtain the data from the internal data sources 170 or the external data sources 180 via the network 102 using the network interface 140 and then stored in the memory apparatus 150.

For the sake of clarity and ease of description, the figures provided herein generally illustrate the transaction data 152, the transaction-data-by-category data 154, the carbon-footprint-by-category data 156, and the carbon index data 158 as each being separate from one another. However, it will be understood that, in some embodiments, these datastores may be combined or the data described as being stored within such datastores may be further separated into additional datastores. For example, in some embodiments, the transaction data 152 includes the transaction-data-by-category data 154, the carbon-footprint-by-category data 156, and carbon index data 158 to combine summaries of individual consumer's greenhouse gas emissions with the actual transaction data contained in the transaction data 152.

In one embodiment, data within each of the four datastores shown in FIG. 1 may be linked to, and thus organized around, each of the individual consumers stored in the memory apparatus 150. In such case, a unique identification is assigned to each individual consumer. Thus, each of the unique identifications is linked within the memory apparatus 150 to the corresponding individual consumer's: (1) transaction data in the transaction data 152; (2) transaction summaries in the transaction-data-by-category data 154; (3) carbon footprint statements in the carbon-footprint-by-category data 156; (4) and carbon index in the carbon index data 158. The unique identifications may be input by the user via the user interface 120, and may be stored by the processing apparatus 130 in any of the four datastores or in a separate datastore within the memory apparatus 150. Furthermore, the user may also create linkages in the memory device 150 between the unique identifications and the data within the four datastores utilizing the user interface 120.

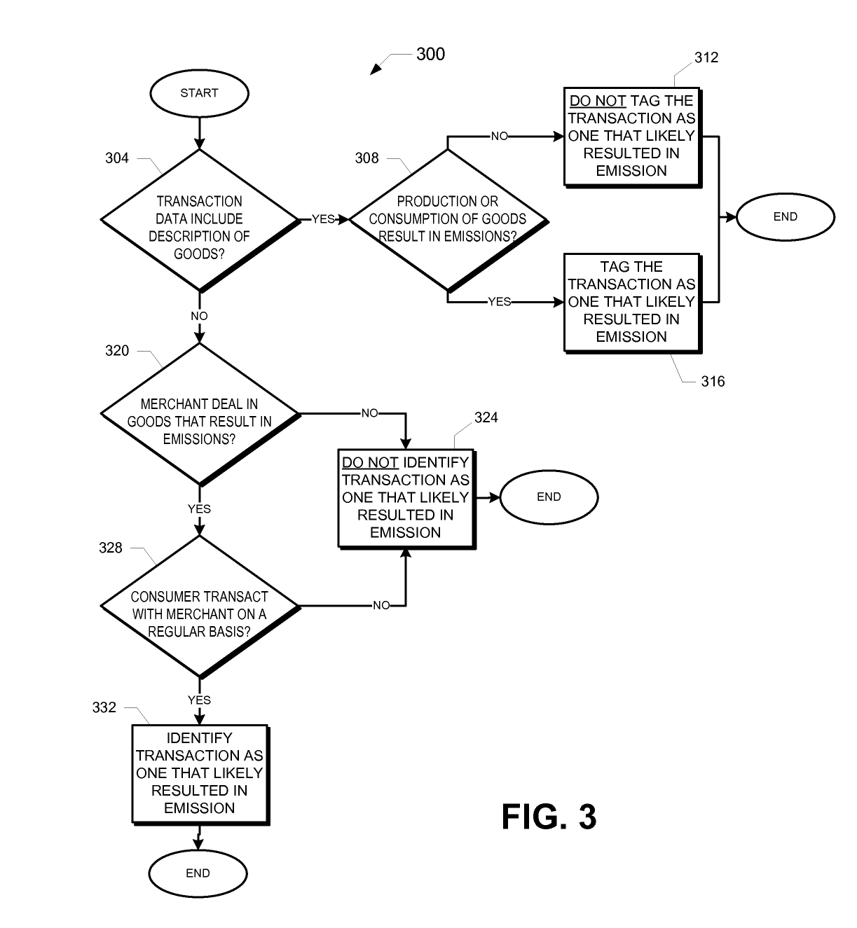

As further illustrated by FIG. 1 and as briefly mentioned above, the memory apparatus 150 also includes the modeling application 160, the carbon-trading platform application 164, and the data-sourcing application 168. As used herein, the term “application” generally refers to computer-readable program code comprising computer-readable instructions and stored on a computer-readable medium, where the instructions instruct a processor to perform certain functions, such as logic functions, read and write functions, and/or the like. In this regard, each of the modeling application 160, the carbon-trading platform application 164, and data-sourcing application 168 includes computer-readable instructions for instructing the processing apparatus 130 and/or other devices to perform one or more of the functions described herein, such as one or more of the functions described in FIGS. 2 and 3. While the modeling application 160, the carbon-trading platform application 164, and data-sourcing application 168 are drawn as separate applications within the memory apparatus 150, it should be understood that the functions of the two applications as described herein could be ascribed to a single application or more than two applications.

FIG. 1 further provides one or more internal data sources 170 and one or more external data sources 180 in communication with the carbon-footprint modeling system 110 via the network 102. In some embodiments, the internal data sources 170 are databases within the network of computer systems of the financial institution utilizing the carbon-footprint modeling system 110 to determine the carbon footprint of individual consumers. The internal data sources 170 may contain data relevant to each of the individual consumers' transactions with the financial institution. According to some embodiments, the internal data sources 170 also contain information about each of the individual consumers provided from third parties, such as other financial institutions and/or data aggregators. In some embodiments, the internal data sources 170 may be certain databases maintained by the financial institution. In some embodiments, all or some of the internal data sources 170 may be the four datastores of the memory device 150, as illustrated in FIG. 1.

The external data sources 180 likewise contain data relevant to the individual consumers' transactions with the financial institution as well as information about the individual consumers provided from third parties, such as other financial institutions and/or data aggregators, however, the external data sources 180 are not located within the network of computer systems of the financial institution utilizing the carbon-footprint modeling system 110 to determine individual consumers' carbon footprint. In some embodiments, both the internal data sources 170 and the external data sources 180 supply data to be relied upon by the carbon-footprint modeling system 110 to carry out the various processes described herein.

FIG. 2 provides a flow diagram illustrating an exemplary process 200 whereby the carbon-footprint modeling system 100 determines a consumer's carbon footprint for a predefined period of time. The carbon-footprint modeling system 100 determines the consumer's carbon footprint based, in part, on the consumer's transaction data 152 for the relevant time period. For example, the relevant time period may be a day, month, quarter, year, decade, and/or any other time period. In some embodiments, the relevant time period is selected by the consumer. For example, in one embodiment, the consumer is able to log in to the consumer's online banking account and view his/her carbon footprint for a particular period of time by entering a period of time into a graphical user interface provided by the carbon-footprint modeling system 100. In some embodiments, the modeling application 160 is configured to compute the consumer's carbon footprint periodically, e.g., each month, thereby dictating the relevant period of time. In other embodiments, other users of the carbon-footprint modeling system 100 can specify or select the relevant period of time.

As indicated at block 204, the process 200 includes obtaining the consumer's transaction data 152 for the relevant time period. According to the illustrated embodiment, the modeling application 160 obtains the consumer's transaction data 152 from the memory device 150. As described above, in some embodiments, this process involves accessing the data about electronic transactions made using one or more bank accounts maintained by a particular financial institution.

Next, as represented by block 208, the modeling application 160 identifies the transactions that likely result in the emission of greenhouse gases. According to some embodiments, the modeling application 160 identifies transactions that likely result in the emission of greenhouse gases based on the business-merchant involved in the transaction. For example, if the business-merchant is a power-generation company, a gasoline company, a waste management company, etc., then the modeling application 160 identifies the transaction as one that likely results in the emission of greenhouse gases. According to some embodiments, the modeling application 160 identifies transactions that likely result in the emission of greenhouse gases based on specific information provided in the transaction. For example, the transaction may provide a description of the goods and/or services that were acquired by the consumer. In other embodiments, such information may be determined from the business-merchant's industry (as determined, for example, for merchant codes associated with electronic financial transactions) and/or consumer annotations.

Referring now to FIG. 3, a flow diagram is provided that illustrates an exemplary process 300 whereby the carbon-footprint modeling environment 100 is utilized to execute the step represented by block 208 of FIG. 2. According to some embodiments, the modeling application 160 executes the process 300 to determine whether a particular transaction, which was taken from the consumer transaction data 152, likely results in greenhouse gas emissions. As indicated at block 304, the process 300 generally begins with determining whether the transaction data associated with the transaction under review includes a description of the goods and/or services underlying the transaction. If the transaction data does include a description of the goods and/or services, then the modeling application 160 determines whether the production and/or consumption of the goods and/or services underlying the transaction would result in greenhouse gas emissions. According to some embodiments, in step 304, the process 300 instructs the modeling application 160 to only determine whether consumption resulted in greenhouse gas emission or to only determine whether production results in greenhouse gas emission. According to some embodiments, to determine whether consumption and/or production results in greenhouse gas emissions, the modeling application 160 references a table stored in the memory 150 that lists products and services and indications as to whether consumption and/or production of the products and services results in greenhouse gas emissions. If consumption and/or production of the product and/or service underlying the transaction results in greenhouse gas emission, then, as indicated by block 312, the modeling application 160 tags the transaction as such. However, if consumption and/or production of the underlying product and/or service do not result in greenhouse gas emission, then, as indicated by block 316, the modeling application 160 does not tag the transaction.

Referring again to the step indicated by block 304, if the transaction data does not include a description of the goods and/or services underlying the transaction, then the modeling application 160 locates in the transaction data associated with the transaction information about the business-merchant with whom the consumer transacted. Then, as indicated by block 320, the modeling application 160 determines whether the business-merchant deals in goods and/or services that result in emissions. According to some embodiments, to determine whether the business-merchant deals in goods and/or services that result in greenhouse gas emissions, the modeling application 160 references a table stored in the memory 150 that lists business-merchants and indications whether the business-merchant deals in products and services that result in greenhouse gas emissions. If the business-merchant does not deal in products and/or services that result in greenhouse gas emission, then, as indicated by block 324, the modeling application 160 does not tag the transaction as one that is likely associated with greenhouse gas emissions.

Referring again to the step indicated by block 320, if the business-merchant does deal in products and/or services that result in greenhouse gas emissions, then the modeling application 160 reviews the consumer's historical transaction data to determine whether the consumer transacts with the business-merchant on a recurring basis, as represented by block 328. If the consumer does not transact with the business-merchant on a recurring basis, then, as indicated by block 324, the modeling application 160 does not tag the transaction as one that is likely associated with greenhouse gas emissions. According to some embodiments of the exemplary process 300, the modeling application 160 does not tag the transaction if the consumer does not transact with the business-merchant on a recurring basis because a single transaction is deemed de minimis. However, if the consumer transacts on a recurring basis with a business-merchant that deals in goods and/or services that result in greenhouse gas emissions, then the consumer consuming goods and/or services that result in greenhouse gas emissions on a recurring basis. According to some embodiments, the modeling application 160, when executing the exemplary process 200, accounts for products and services consumed on a recurring basis because these products and/or services likely account for a non-de minimis portion of the consumer's carbon footprint. For example, recurring transactions with business-merchants that deal in goods and/or services that result in greenhouse gas emissions may indicate that the business-merchant is, for example, a power supply company or an automobile gasoline company. Accordingly, if, after reviewing the consumer's historical transaction data, the modeling application 160 determines that the consumer transacts with the business-merchant on a recurring basis, then, as indicated at block 332, the modeling application 160 tags the transaction as likely resulting in greenhouse gas emission.

In some embodiments, if the business-merchant only deals in one good or service or a very limited number of goods and/or services, then the modeling application 160 may be able to skip step 328 and make assumptions about what the consumer purchased and determine whether the good and/or service involved in the transaction results in greenhouse gas emissions.

With reference again to FIG. 2, after the modeling application 160 identifies the transactions that likely result in the emission of greenhouse gases, according to the process 200 for determining a consumer's carbon footprint, the modeling application 160 categorizes the identified transactions and stores the categorized transactions in the transaction-data-by-category data 154, as represented by block 212. According to an embodiment, the modeling application 160 categorizes the transactions into at least one of the following categories: transportation, housing, food, waste, and miscellaneous. According to some embodiments, the modeling application 160 categorizes transactions based on the business-merchant involved in the transaction. For example, if the business merchant is an automobile gasoline company, then the modeling application 160 assigns that transaction to the transportation category. Similarly, for example, if the business merchant is a power generation company, then the modeling application 160 assigns that transaction to the household category because the consumer would be transacting with the power generation company to provide electricity to the consumer's household. Also, according to some embodiments, the modeling application 160 categorizes transactions based specific information provided in the transaction. For example, as mentioned above, the transaction may provide a description of the goods and/or services that were acquired by the consumer. In this case modeling application 160 categorizes transactions based on the type of good(s) and/or service(s) that were the subject of the transaction.

As represented by block 216, the modeling application 160 calculates the quantity of greenhouse gas emissions associated with each identified transaction. According to some embodiments, to calculate the quantity of green of greenhouse gas emissions, the modeling application 160 applies conversion formulas to each of the individual transactions. For example, for some transactions, the modeling application 160 applies conversion formulas to convert the dollar-value of the transaction, which—in addition to the location of the transaction and the identity of the business-merchant with whom the consumer transacted—is sometimes the only information provided in the transaction data, into a quantity of the good and/or service. For example, if a particular transaction involves a thirty-dollar purchase at an automobile gasoline company, the modeling application 160 applies conversion formulas specific to the date and geographic location of the transaction to convert the thirty-dollar purchase into a quantity of gasoline. In one example, the conversion formulas assume the cost of the purchased gasoline was two dollars per gallon. Accordingly, the modeling application 160 converts the thirty-dollar transaction between the consumer and the automobile gasoline merchant into fifteen gallons of gasoline.

Next, after quantifying the good and/or service, the modeling application 160 applies conversion formulas to convert the quantity of the good and/or service into a quantity of greenhouse gas emissions that resulted from the production and/or consumption of that good and/or service. Referring again to the automobile gasoline example provided above, the modeling application 160 would convert the fifteen gallons of gasoline into a quantity of greenhouse gas emission. In this example, the modeling application 160 assumes the consumer combusted all of the purchased gasoline in an automobile with average efficiency operating in average conditions and, accordingly, applies conversion formulas that convert the gallons of gasoline combusted in the consumer's automobile into a quantity of greenhouse gas emission. For example, according to the EPA, an average automobile emits 8.89×10̂−3 metric tons carbon dioxide per gallon of gasoline combusted. Thus, if applying the EPA's conversion ratio, the modeling application 160 would multiply fifteen gallons by 8.89×10̂−3 metric tons carbon dioxide per gallon to determine the quantity of greenhouse gases that resulted from the transaction in which the consumer made a thirty-dollar purchase from an automobile gasoline merchant.

According to some embodiments, to convert the quantity of gasoline into a quantity of greenhouse gas emissions, the modeling application 160 converts the quantity of gasoline into a number of miles driven and then converts the number of miles driven into a quantity of greenhouse gas emissions. For example, the modeling application 160 assumes the consumer's automobile's efficiency, e.g., twenty-five miles per gallon, and then multiplies that efficiently by the quantity of gasoline. In this example, if the consumer's automobile's averaged twenty-five miles per gallon, then the consumer would drive 375 miles on fifteen gallons of gasoline. Accordingly, the consumer's thirty-dollar purchase at the automobile gasoline merchant resulted in 375 miles driven. Further, according to this example, after determining the number of miles driven, the modeling application 160 applies conversion formula to convert miles driven into a quantity of greenhouse gas emissions. In some instances, an average miles-per-gallon is used the consumers, while, in other instances, a consumer may be permitted to enter a particular miles-per-gallon for the consumer's car.

In sum, for this exemplary transaction where the consumer made a thirty-dollar purchase from an automobile gasoline merchant, the modeling application 160 converts the price of the transaction into a quantity of gasoline consumed, and then converts the quantity of gasoline consumed into a quantity of greenhouse gases emitted. According to some embodiments, the modeling application 160 applies conversion formulas to calculate a quantity of greenhouse gas emissions associated with the production of the consumed gasoline. That is, the modeling application 160, according to some embodiments, also accounts for the greenhouse gases emitted when removing the crude oil from the earth, shipping the crude oil, refining the crude oil into gasoline, and then shipping the gasoline.

In some embodiments, the calculations described above are conducted for each transaction as appropriate, while, in other embodiments, the transactions can be simplified by determining conversion factors for common transactions that convert the dollar amount directly into units of greenhouse gas.

In some embodiments of the invention, the consumer or other user of the system can view the greenhouse gas emissions per transaction. For example, the consumer may be able to log into the consumer's online banking account and view the units of greenhouse gas emissions associated with each transaction in the consumer's online bank statement. In one embodiment, the emissions are broken down for the user based on the type of greenhouse gas.

After the greenhouse gas emissions associated with each transaction are calculated, the modeling application 160 calculates the consumer's carbon footprint for each of the categories and then stores the calculated carbon footprints in the carbon-footprint-by-category data 156, as represented by block 220. According to some embodiments, to calculate the consumer's carbon footprint for a particular category, the modeling application 160 aggregates the quantity of greenhouse gas emissions associated with each transaction in the category. In some embodiments, the modeling application 160 displays the carbon footprint per category to the consumer or other user via a graphical user interface. For example, embodiments of the present invention may provide charts and graphs for the user that show the consumer's carbon footprint per category and overall carbon footprint, and, in some instances, compares the consumer's carbon footprint(s) to that of an average or peer consumer for whom transaction data is available. Such a graphical user interface may allow the user to specify a time period for the carbon footprint, view carbon footprint history, and/or view carbon footprint projections.

After the modeling application 160 has calculated the consumer's carbon footprint for each category and stored that information in the carbon-footprint-by-category data 156, the modeling application 160, as indicated at block 224, calculates a carbon index that represents the consumer's total carbon footprint for the preselected period of time and stores the calculated carbon index in the carbon index data 158. According to some embodiments, to calculate the carbon index, the modeling application 160 aggregates the consumer's carbon footprint across all categories.

As mentioned above, in some embodiments, within each category, the modeling application 160 calculates the quantity of greenhouse gas emitted on a per transaction basis for a preselected period of time and then aggregates the quantity of greenhouse gas emissions associated with each transaction to calculate the consumer's carbon footprint for that category for the preselected period of time. However, it should be appreciated that, instead of calculating the quantity of greenhouse gas emitted on a per transaction basis, the modeling application 160 could identify patterns in the consumer's weekly or monthly behavior and then extrapolate those patterns to calculate the quantity of greenhouse gas emitted as a result of those weekly or monthly periods over a longer period of time, e.g., one or two years. For example, the modeling application 160 may observe that, over the course of a one-year period, the consumer made, on average, a thirty-dollar purchase from the automobile gasoline merchant on a weekly basis. That the consumer made weekly purchases from the automobile merchant further confirms the assumption that the consumer is buying automobile gasoline from the merchant. In this case, based on the exemplary conversion formulas discussed above, the modeling application 160 determines that consumer purchased and consumed fifteen gallons of gasoline per week by driving 375 miles per week. This may be used by the modeling application 160 to estimate that the consumer purchased and consumed approximately 780 gallons in one year by driving 19,500 miles in one year. Accordingly, using the identified pattern, the modeling application 160 determines the carbon footprint, i.e., the quantity of emitted greenhouse gas, resulting from the consumer's weekly transaction at the automobile gasoline merchant during the course of a year.

Referring again to FIG. 1, the carbon-trading application 164 of the carbon-footprint modeling environment 110 will now be discussed in more detail. After the modeling application 160 determines a carbon index for each of a plurality of consumers, the carbon-trading platform 164 compiles the customers' carbon indexes into a carbon fund, which can be used to determine the amount of money and resources that need to be invested into green projects or green technology to offset the consumers', collective or individual, carbon footprint(s). For example, according to an embodiment, the carbon-trading platform 164 presents an individual consumer with information about the consumer's carbon index and offers the consumer an opportunity to buy shares of a carbon-offset fund that are equal in value to the consumer's carbon footprint, thereby giving the consumer the opportunity to offset his greenhouse gas emissions. Any money the consumer pays into the carbon-offset fund is invested in green projects, green technology development, and other carbon minimizing projects. Further, instead of or in addition to buying carbon offsets, those consumers having favorable carbon indexes will have the benefit of selling carbon credits into the carbon-offset fund. A consumer may have favorable carbon index by, for example, having a negative carbon footprint or by having a carbon footprint that is less than the average consumer or the average peer consumer. A consumer may be in such positions by being conscious of their carbon footprint when they purchase goods and/or services, by buying carbon-offset fund shares, or by engaging in carbon footprint offsetting activities such as recycling, buying and planting a tree, supporting certain “green” organizations or projects, working in a “green” job or volunteer program, and/or the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
collecting from a datastore a plurality of transaction data associated with a consumer;
identifying in the transaction data at least one transaction associated with emission of greenhouse gas; and
using a processor to calculate a quantity of greenhouse gas emission associated with the at least one transaction.

2. The method of claim 1, wherein the at least one transaction comprises a plurality of transactions associated with emission of greenhouse gas.

3. The method of claim 2, further comprising:
determining a carbon footprint for the consumer for a period of time by aggregating the quantity of greenhouse gas emissions associated with each of the plurality of transactions that occurred during the period of time.

4. The method of claim 1, wherein identifying the at least one transaction comprises:
identifying in the transaction data the at least one transaction in which the consumer transacted with a business-merchant that is associated with goods or services that, when produced or consumed, result in the emission of greenhouse gas.

5. The method of claim 1, wherein identifying the at least one transaction comprises:
identifying in the transaction data the at least one transaction in which the consumer transacted with a business-merchant on a recurring basis and the business-merchant is associated with goods or services that, when produced or consumed, result in the emission of greenhouse gas.

6. The method of claim 1, wherein identifying the at least one transaction comprises:
identifying in the transaction data the at least one transaction in which the transaction involves at least a good or service that, when produced or consumed, results in the emission of greenhouse gas.

7. The method of claim 1, further comprising:
categorizing the at least one transaction associated with the emission of greenhouse gas.

8. The method of claim 7, wherein the at least one transaction is categorized into at least one of a transportation category and a housing category.

9. The method of claim 1, wherein calculating the quantity of greenhouse gas emission associated with the at least one transaction comprises:
applying a conversion formula to convert a dollar-value associated with the transaction into a quantity of a good or service; and
applying a second conversion formula to convert the quantity of the good or service into a quantity of greenhouse gas emission that results from the production and/or consumption of the good or service.

10. An apparatus comprising:
a memory device comprising a plurality of transaction data for a consumer;
a processor operatively coupled to the memory device and configured to:
identify in the transaction data at least one transaction associated with emission of greenhouse gas; and
calculate a quantity of greenhouse gas emission associated with the at least one transaction.

11. The apparatus of claim 10, wherein the at least one transaction comprises a plurality of transactions associated with emission of greenhouse gas.

12. The apparatus of claim 11, wherein the processor is further configured to:
determine a carbon footprint for the consumer for a period of time by aggregating the quantity of greenhouse gas emissions associated with each of the plurality of transactions that occurred during the period of time.

13. The apparatus of claim 10, wherein the processor is configured to identify the at least one transaction by being configured to:
identify in the transaction data the at least one transaction in which the consumer transacted with a business-merchant that is associated with goods or services that, when produced or consumed, result in the emission of greenhouse gas.

14. The apparatus of claim 10, wherein the processor is configured to identify the at least one transaction by being configured to:
identify in the transaction data the at least one transaction in which the consumer transacted with a business-merchant on a recurring basis and the business-merchant is associated with goods or services that, when produced or consumed, result in the emission of greenhouse gas.

15. The apparatus of claim 10, wherein the processor is configured to identify the at least one transaction by being configured to:
identify in the transaction data the at least one transaction in which the transaction involves at least a good or service that, when produced or consumed, results in the emission of greenhouse gas.

16. The apparatus of claim 10, wherein the processor is further configured to:
categorize the at least one transaction associated with emission of greenhouse gas.

17. The apparatus of claim 16, wherein the processor is configured to categorize the at least one transaction into at least one of a transportation category and a housing category.

18. The apparatus of claim 10, wherein the processor is configured to calculate the quantity of greenhouse gas emission associated with the at least one transaction by being configured to:
apply a conversion formula to convert a dollar-value associated with the transaction into a quantity of a good or service; and
apply a second conversion formula to convert the quantity of the good or service into a quantity of greenhouse gas emission that resulted from the production and/or consumption of the good or service.

19. A computer program product for determining a carbon footprint of a consumer, the computer program product comprising a non-transitory computer-readable medium having computer-executable program code stored therein, wherein said computer-executable program code comprises:
a first executable code portion configured to collect from a datastore a plurality of transaction data associated with a consumer;
a second executable code portion configured to identify in the transaction data at least one transaction associated with emission of a greenhouse gas; and
a third executable code portion configured to calculate a quantity of greenhouse gas emission associated with the at least one transaction.

20. The computer program product of claim 19, wherein the at least one transaction comprises a plurality of transactions associated with emission of greenhouse gas.

21. The computer program product of claim 20, further comprising:
an executable code portion configured to determine a carbon footprint for the consumer for a period of time by aggregating the quantity of greenhouse gas emissions associated with each of the plurality of transactions that occurred during the period of time.

22. The computer program product of claim 19, wherein the second executable code portion configured to identify the at least one transaction comprises:
an executable code portion configured to identify in the transaction data the at least one transaction in which the consumer transacted with a business-merchant that is associated with goods or services that, when produced or consumed, result in the emission of greenhouse gas.

23. The computer program product of claim 19, wherein the second executable code portion configured to identify the at least one transaction comprises:
an executable code portion configured to identify in the transaction data the at least one transaction in which the consumer transacted with a business-merchant on a recurring basis and the business-merchant is associated with goods or services that, when produced or consumed, result in the emission of greenhouse gas.

24. The computer program product of claim 19, wherein the second executable code portion configured to identify the at least one transaction comprises:
an executable code portion configured to identify in the transaction data the at least one transaction in which the transaction involves at least a good or service that, when produced or consumed, results in the emission of greenhouse gas.

25. The computer program product of claim 19, further comprising:
an executable code portion configured to categorize the at least one transaction associated with emission of greenhouse gas.

26. The computer program product of claim 25, wherein the at least one transaction associated with emission of greenhouse gas is categorized into at least one of a transportation category and a housing category.

27. The computer program product of claim 19, wherein the third executable code portion configured to calculate the quantity of greenhouse gas emission associated with the at least one transaction comprises:
an executable code portion configured to apply a conversion formula to convert a dollar-value associated with the transaction into a quantity of the good or service; and
an executable code portion configured to apply a second conversion formula to convert the quantity of the good or service into a quantity of greenhouse gas emission that resulted from the production and/or consumption of the good or service.

28. An apparatus comprising:
a memory device comprising financial transaction data stored therein, wherein the financial transaction data comprises information about a plurality of purchases made by a consumer;
a processor operatively coupled to the memory device and configured to:
identify in the financial transaction data at least one purchase of a good or service the production or consumption of which results in a byproduct; and
calculate a quantity of the byproduct associated with the at least one purchase.

29. The apparatus of claim 28, wherein the processor is further configured to:
identify in the financial transaction data a plurality of purchases made by the consumer during a period of time, wherein each of the plurality of purchases comprises a purchase of a good or service the production or consumption of which results in the byproduct;
calculate a quantity of the byproduct associated with each of the plurality of purchases;
aggregate the quantity of the byproduct associated with each of the plurality of purchases; and
determine a total quantity of the byproduct associated with the consumer for the period of time based at least partially on the aggregate of the quantity of the byproduct associated with the plurality of purchases.

30. The apparatus of claim 28, wherein the financial transaction data comprises information about purchases made using a financial account.

31. The apparatus of claim 28, wherein the financial transaction data comprises information about electronic payments made using a bank account.

32. The apparatus of claim 28, wherein the byproduct comprises one or more greenhouse gases.

33. The apparatus of claim 32, wherein the one or more greenhouse gases comprise carbon dioxide, methane, nitrous oxide, or chlorofluorocarbons.

34. The apparatus of claim 28, wherein the processor is further configured to:
determine a byproduct footprint for a consumer based at least partially on the quantity of the byproduct associated with the at least one purchase.

35. The apparatus of claim 34, wherein the processor is further configured to:
identify in the financial transaction data at least one byproduct-offsetting transaction for the consumer where the transaction is associated with a reduction of the byproduct; and
revise the byproduct footprint based at least partially on the at least one byproduct-offsetting transaction.

36. The apparatus of claim 35, wherein the byproduct-reducing transaction comprises a purchase of a share of a byproduct offset fund, the byproduct offset fund comprising an investment in byproduct offsetting projects or organizations.

37. The apparatus of claim 34, wherein the processor is further configured to:
display information about the consumer's byproduct footprint in the consumer's online banking environment.

38. The apparatus of claim 34, wherein the processor is further configured to:
display information about the consumer's byproduct footprint in relation to a byproduct footprint of an average or peer consumer.

39. A method comprising:
accessing financial transaction data, wherein the financial transaction data comprises information about a plurality of purchases made by a consumer;
identifying in the financial transaction data at least one purchase of a good or service the production or consumption of which results in a byproduct; and
using a processor to calculate a quantity of the byproduct associated with the at least one purchase.

40. The method of claim 39, further comprising:
identifying in the financial transaction data a plurality of purchases made by the consumer during a period of time, wherein each of the plurality of purchases comprises a purchase of a good or service the production or consumption of which results in the byproduct;
calculating a quantity of the byproduct associated with each of the plurality of purchases;
aggregating the quantity of the byproduct associated with each of the plurality of purchases; and
determining a total quantity of the byproduct associated with the consumer for the period of time based at least partially on an aggregate of the quantity of the byproduct associated with the plurality of purchases.

41. The method of claim 39, wherein the byproduct comprises one or more greenhouse gases.

42. The method of claim 39, further comprising:
determining a byproduct footprint for a consumer based at least partially on the quantity of the byproduct associated with the at least one purchase.

43. The method of claim 42, further comprising:
identifying in the financial transaction data at least one byproduct-offsetting transaction for the consumer where the transaction is associated with a reduction of the byproduct; and
revising the byproduct footprint based at least partially on the at least one byproduct-offsetting transaction.

44. The method of claim 42, further comprising:
displaying information about the consumer's byproduct footprint in the consumer's online banking environment.

45. The method of claim 42, further comprising:
displaying information about the consumer's byproduct footprint in relation to a byproduct footprint of an average or peer consumer.

46. The method of claim 42, further comprising:
selling shares of a byproduct offset fund, the byproduct offset fund comprising an investment in byproduct offsetting projects or organizations; and
revising the byproduct footprint based at least partially on the consumer's purchase of a share of a byproduct offset fund.
